(19) United States
(12) Patent Application Publication
(10) Pub. No.: US 2006/0178108 A1
(43) Pub. Date: Aug. 10, 2006

(54) Method and apparatus for controlling radio wave transmission from a portable information processing device

(76) Inventors: Yuji Chotoku, Kawasaki-shi (JP); Kan Sasaki, Yamato-shi (JP)

Correspondence Address: DILLION & YUDELL LLP, 8911 N. CAPITAL OF TEXAS HWY, SUITE 2110, AUSTIN, TX, 78759, US

(21) Appl. No.: 11/350,499

(22) Filed: Feb. 9, 2006

(30) Foreign Application Priority Data
Feb. 9, 2005 (JP) 2005-33285

(51) Int. Cl. H04B 1/06

(52) U.S. Cl. 455/26.1

(57) ABSTRACT

An information processing device capable of controlling radio wave transmission is disclosed. The information processing device includes an acceleration detection unit and a flag setting unit. The acceleration detection unit detects an acceleration applied to the information processing device. In response to the magnitude of the detected acceleration and the magnitude of the tilt of an airplane determined from the detected acceleration being larger than a predetermined value, the flag setting unit sets a stopping flag. Then, the flag setting unit stops any radio wave transmission from the information processing device.

### RELATED PATENT APPLICATION

The present patent application claims priority to a Japanese Patent Application No. 2005-33285, filed on Feb. 9, 2005.

### BACKGROUND OF THE INVENTION

1. Technical Field

The present invention relates to portable information processing devices in general, and in particular to a method and apparatus for controlling radio wave transmission from a portable information processing device.

2. Description of Related Art

The usage of portable information processing devices has been increasing in recent years. Such portable information processing devices typically transmit radio wave when they are in an ON state. However, there are places where radio wave transmissions from portable information processing devices are prohibited. Thus, some of the portable information processing devices are equipped with a control mechanism that can stop radio wave transmission if necessary.

For example, when a user presses a release button on a portable information processing device, a stopping command is issued, and the transmission of radio wave is stopped in response to such stopping command. Since the user can control radio wave transmission without turning off the portable information processing device, the user can continue to use other functions provided in the portable information processing device while the radio wave transmission is stopped.

Some portable information processing devices have an acceleration sensor that can detect whether or not the information processing devices are in motion. Based on the result of the detection, the state (i.e., ON, OFF or the like) of the information processing device is changed to stop any radio wave transmission. Since the portable information processing device can stop radio wave transmission by itself, it is not necessary for a user to perform any operation in order to stop radio wave transmission from the portable information processing device. However, the state of the portable information processing device is changed only based on the detection of whether or not there is a horizontal movement but not vertical movement. Thus, the portable information processing device cannot distinguish whether a user is traveling on an automobile, train or airplane.

Consequently, it would be desirable to provide an improved method and apparatus for controlling radio wave transmission from a portable information processing device.

### SUMMARY OF THE INVENTION

In accordance with a preferred embodiment of the present invention, an information processing device located on board of an airplane includes an acceleration detection unit and a flag setting unit. The acceleration detection unit detects an acceleration applied to the information processing device. In response to the magnitude of the detected acceleration and the magnitude of the tilt of the airplane determined from the detected acceleration being larger than a predetermined value, the flag setting unit sets a stopping flag. Then, the flag setting unit stops any radio wave transmission from the information processing device.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram of an information processing device, in accordance with a preferred embodiment of the present invention;

FIG. 2 is a flow diagram of the detection operation within the information processing device from FIG. 1, in accordance with a preferred embodiment of the present invention;

FIG. 3 is a flow diagram of a start-up sequence of the information processing device from FIG. 1, in accordance with a preferred embodiment of the present invention;

FIG. 4 shows an embodiment of the present invention when an airplane takes off;

FIG. 5 shows an embodiment of the present invention when an airplane makes a landing;

FIG. 6 is a conceptual diagram for calculating a reference vector, in accordance with a preferred embodiment of the present invention;

FIG. 7 is a flow diagram for a flag setting unit performing a first determination, in accordance with a preferred embodiment of the present invention;

FIG. 8 is a flow diagram for a flag setting unit performing a second determination, in accordance with a preferred embodiment of the present invention;

FIG. 9 graphically illustrates an image shown on a display unit when radio wave transmission is stopped, in accordance with a preferred embodiment of the present invention; and

FIG. 10 is a low diagram of a method for permitting radio wave transmissions, in accordance with a preferred embodiment of the present invention.

### DETAILED DESCRIPTION OF A PREFERRED EMBODIMENT

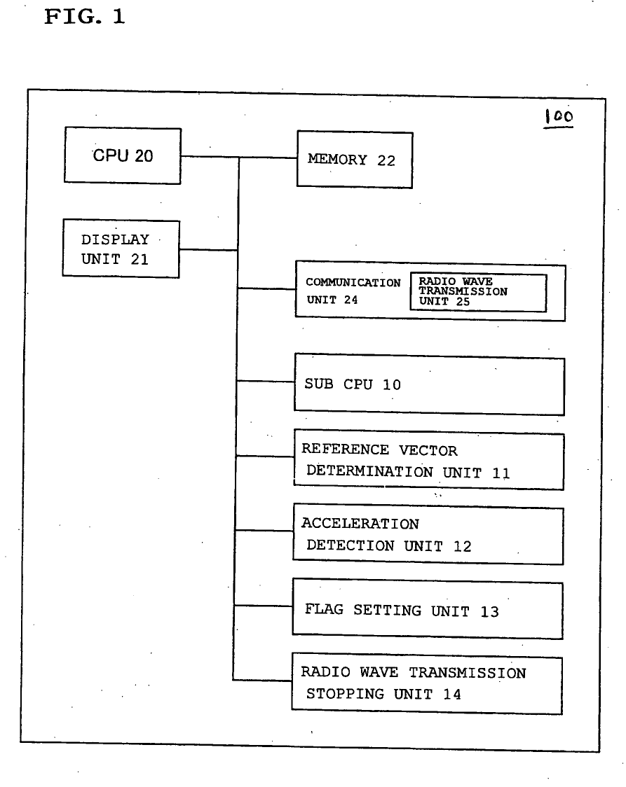

Referring now to the drawings and in particular to FIG. 1, there is depicted a block diagram of an information processing device, in accordance with a preferred embodiment of the present invention. As shown, an information processing device 100 includes a sub central processing unit (CPU) 10 that operates even when information processing device 100 is turned off by a user, a reference vector determination unit 11 that determines a reference vector based on the magnitude and direction of gravity acceleration applied to information processing device 100, an acceleration detection unit 12 that detects a gravity acceleration and an acceleration applied to information processing device 100, a flag setting unit 13 that sets a stopping flag for indicating whether or not radio wave transmission is stopped, a radio wave transmission stopping unit 14 that generates a signal for stopping radio wave transmission, a CPU 20 that computes (or calculates) and controls the flow of programs and data, a display unit 21 that displays data processed by CPU 20, a memory 22 that stores programs, data, processing results, etc. from CPU 20, a communication unit 24, disposed between information processing device 100 and a communications line that controls transmitting/receiving of data, and a radio wave transmitting unit 25 that controls radio wave transmission.

Information processing device 100 is preferably a portable data processing device such as a notebook computer or a personal digital assistance (PDA).

Sub CPU 10 includes a cache memory. Sub CPU 10 may control reference vector determination unit 11, acceleration detection unit 12 and flag setting unit 13. Alternatively, programs may be stored in sub CPU 10 or CPU 20, whereby sub CPU 10 or CPU 20 functions as reference vector determination unit 11, acceleration detection unit 12 and flag setting unit 13.

Using an internal battery, sub CPU 10 operates even when the power is in the OFF state or in a standby state. Accordingly, reference vector determination unit 11, acceleration detection unit 12 and flag setting unit 13 can operate even when the power is in the OFF state or in a standby state.

Reference vector determination unit 11 determines the direction and magnitude of gravity acceleration applied to information processing device 100 in a normal operation state in which information processing device 100 is not affected from any other acceleration except for gravity basically. Reference vector is defined as a vector serving as a reference in determining the degree of acceleration applied to information processing device 100. More specifically, reference vector is defined as a vector serving as a reference in determining the degree and direction of acceleration when information processing device 100 is being accelerated. Accordingly, reference vector is determined based on the magnitude and direction of acceleration applied to information processing device 100 before information processing device 100 is accelerated, and is compared with the magnitude and direction of acceleration after information processing device 100 has been accelerated. Reference vector may be determined at a predetermined interval time. More specifically, when the direction of arrangement of information processing device 100 varies, the direction of acceleration applied to information processing device 100 also varies. Accordingly, reference vector may be determined at a predetermined interval of time so that reference vector is updated by reference vector determination unit 11.

Acceleration detection unit 12 detects an acceleration applied to information processing device 100. More specifically, acceleration detection unit 12 detects the direction and magnitude of acceleration applied to information processing device 100. Thus, when only gravity acceleration is being applied to information processing device 100 in a stationary state, only gravity acceleration is detected. When information processing device 100 is being accelerated, acceleration associated with the increase in speed as well as gravity acceleration are detected.

Acceleration detection unit 12 is, for example, a “3D G-sensor” that includes a piezoelectric ceramic device and an electrode, and of which the piezoelectric ceramic device is strained by inertial force according as the acceleration is applied from the outside, whereby stress is generated within the piezoelectric ceramic device. This stress is then converted to electric signals (charges) by piezoelectric effect, and the direction and magnitude of acceleration are detected from the electric signals. For example, “3D G-Sensor” is used to interrupt the writing of data and thereby protects data of adjacent tracks from being improperly overwritten, when a hard disk drive or an optical disk drive receives a shock.

Flag setting unit 13 determines whether or not, with the magnitude of acceleration vector detected by acceleration detection unit 12 equal to or larger than a predetermined value, a predetermined time period has passed (first determination), and at the same time determines whether or not the angle between the acceleration vector and the reference vector determined by the reference vector determination unit 11 is larger than a predetermined value (second determination). When the above-mentioned conditions are met, flag setting unit 13 stores a stopping flag to memory 22. The stopping flag may also be stored to any given location such as a cache memory provided within sub CPU 10.

In response to the stopping flag, radio wave transmission stopping unit 14 sends a signal to stop radio wave transmission unit 25.

Each of reference vector determination unit 11, acceleration detection unit 12, flag setting unit 13 and radio wave transmission stopping unit 14 may be constructed as a separate unit as shown in FIG. 1, or they may be constructed as a single unit or as any given combination of units. Radio wave transmission stopping unit 14 may be contained in a Basic Input/Output System (BIOS). The BIOS is a program for controlling the basic operation of information processing device 100.

Communication unit 24 along with radio wave transmitting unit 25 control communications transmitting/receiving of data. Herein, communications denotes a wireline or wireless bidirectional communication. Communication unit 24 can be a wireless LAN adaptor connected to a wireless LAN.

Radio wave transmitting unit 25 stops radio wave transmission in response to a signal sent from radio wave transmission stopping unit 14. Radio wave transmission can be controlled based on radio wave transmitting unit 25. Radio wave transmitting unit 25 can be contained, for example, in a logical layer controller performing conversion between digital signal and analog signal, and in an RF/IF converter. RF is an abbreviation of Radio Frequency and denotes a signal of 2.4 GHz band. IF is an abbreviation of Intermediate Frequency and denotes a signal of 600 MHz band. More specifically, in radio wave transmitting unit 25, a signal of 2.4 GHz can be down-converted to a signal of about 600 MHz to be processed.

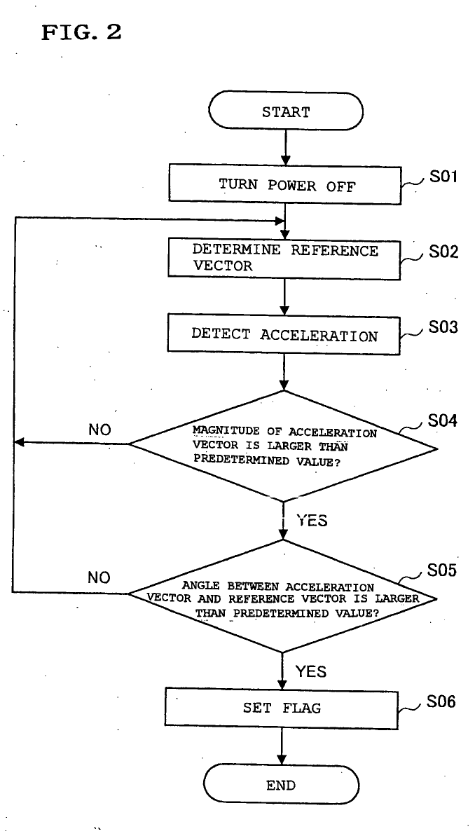

With reference now to FIG. 2, there is illustrated a flow diagram of detection operations of information processing device 100, in accordance with a preferred embodiment of the present invention. When a notebook PC is taken by a user to the airplane and the airplane takes off, the notebook PC acquires the information of takeoff, and when the user turns on the notebook PC, the notebook PC stops any radio wave transmission.

As sub CPU 10 detects the OFF state or a standby state of information processing device 100, as shown in step S01, reference vector determination unit 11 determines a reference vector based on the magnitude and direction of gravity acceleration detected by acceleration detection unit 12, as depicted in step S02. Subsequently, acceleration detection unit 12 detects an acceleration applied to information processing device 100 and calculate an acceleration vector, as shown in S03.

In step S04, flag setting unit 13 determines whether or not the magnitude of the acceleration vector is larger than a predetermined value (first determination). If so, the flow proceeds to step S05; if not, the flow proceeds to step S02.

In step S05, flag setting unit 13 determines whether or not the angle between the reference vector determined in step S02 and the acceleration vector generated in step S03 are larger than a predetermined value (second determination). If so, the flow proceeds to step S06; if not, the flow proceeds to step S02.

In step S06, flag setting unit 13 stores a stopping flag in memory 22. Based on the gravity acceleration and the acceleration applied to information processing device 100, flag setting unit 13 sets a stopping flag for stopping radio wave transmission performed by communication unit 24. For example, if the stopping flag is set when a notebook PC is turned on, the notebook PC can be used during the takeoff of an airplane.

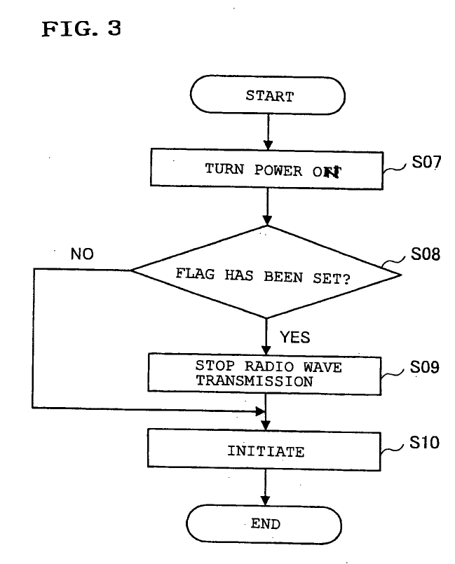

Referring now to FIG. 3, there is depicted a start-up sequence executed when information processing device 100 is turned on, or when information processing device 100 returns from a standby state, in accordance with a preferred embodiment of the present invention. A passenger takes a notebook PC to an airplane and enters it to a standby state before takeoff, then he uses it again after takeoff.

In response that sub CPU 10 detects the ON state of information processing device 100, or the return from a standby state, as shown in step S07, radio wave transmission stopping unit 14 determines whether or not a stopping flag is set, as depicted in step S08. If so, the flow proceeds to step S09; if not, the flow proceeds to step S10. Also, if a stopping flag is set, radio wave transmission stopping unit 14 sends a signal for stopping radio wave transmission to radio wave transmitting unit 25.

In step S09, radio wave transmitting unit 25 stops radio wave transmission in response to the signal sent from radio wave transmission stopping unit 14.

In step S10, the power-on sequence is executed. More specifically, by loading a BIOS, information processing device 100 is initiated, or information processing device 100 returns from a standby state. For example, when the BIOS includes radio wave transmitting unit 25, the BIOS is loaded and then a processing of step S09 of stopping radio wave transmission is first executed.

In sum, before information processing device 100 is initiated, radio wave transmission stopping unit 14 checks a stopping flag before the start-up processing is executed by the notebook PC. By checking a stopping flag when a notebook PC is initiated, radio wave is prevented from being automatically transmitted from the notebook PC.

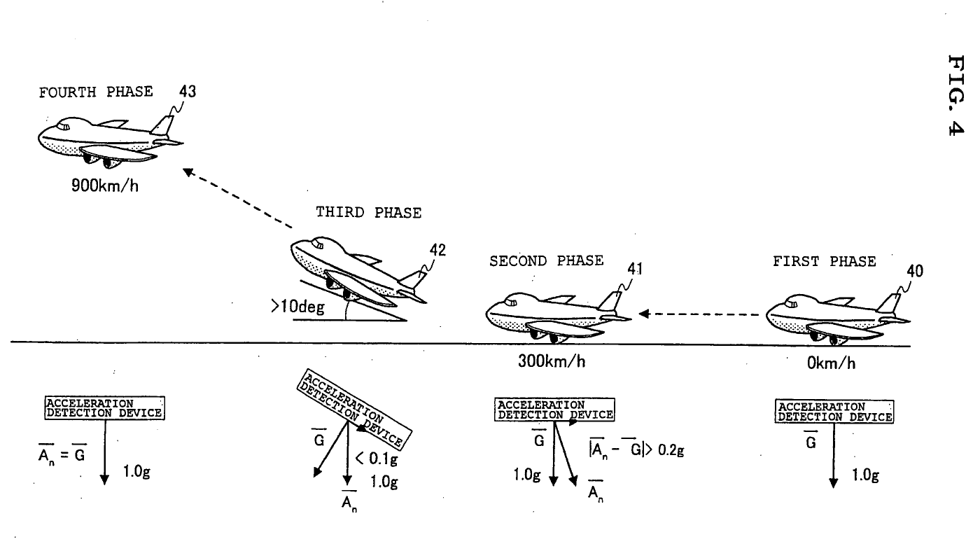

With reference now to FIG. 4, there is depicted an embodiment of the present invention when an airplane takes off. Airplanes 40 to 43 shown in FIG. 4 represent the state of the airplane in the order of time (a first phase to a fourth phase). Airplanes 40-43 represent the same airplane. Herein, acceleration detection device denotes a device including acceleration detection unit 12. Information processing device 100 equipped with acceleration detection device 12 is on board within the airplane.

I. Stationary State Before Takeoff (First Phase)

In the first phase, an airplane 40 is in a stationary state. In this state, airplane 40 has a speed of 0 km/hr. Acceleration in a direction perpendicular to airplane 40 and a gravity direction is 0 G. Applied to information processing device 100 is a gravity acceleration of 1.0 G.

Information processing device 100 is turned off or changed to a standby state by a user operation. However, sub CPU 10 is active, and acceleration detection unit 12 detects a gravity acceleration and an acceleration applied to information processing device 100.

Also, reference vector determination unit 11 determines a reference vector (G). In the present example, reference vector determination unit 11 determines a reference vector (G) down in a vertical direction. Sub CPU 10 repeats these processing of determining a reference vector until information processing device 100 is turned on or returned from a standby state by a user operation.

II. State of Takeoff Run (Second Phase)

In the second phase, airplane 41 is running at a speed of about 300 km/hr. An acceleration of about 0.2 G or more in a direction opposite to the direction of movement and a gravity acceleration of 1.0 G in a vertical direction affect to information processing device 100. More specifically, flag setting unit 13 determines a difference between the reference vector (G) determined in the first phase and acceleration vector An, and calculates the absolute value of the difference, and then determines whether or not an acceleration of about 0.2 G or more is applied in a direction opposite to the direction of movement.

Flag setting unit 13 checks to see if the first determination is satisfied, that is, whether or not, with the magnitude of acceleration vector detected by acceleration detection unit 12 equal to or larger than a predetermined value and it continues for more than a predetermined time period.

III. State of Takeoff and Nose-Up Attitude (Third Phase)

After takeoff, until airplane 42 reaches an objective altitude, it is gaining altitude by a tilt of about 10 degrees or more relative to the horizontal line. In the third phase, an acceleration of about 0.1 G or less in a direction opposite to the direction of movement and a gravity acceleration of 1.0 G in a vertical direction are applied to information processing device 100.

Information processing device 100 detects a direction of acceleration vector and then determines that airplane 42 inclines some angle. More specifically, flag setting unit 13 of information processing device 100 calculates an angle between the reference vector determined by reference vector determination unit 11 and the acceleration vector, and checks that the second determination is satisfied, that is, whether or not the angle is larger than a predetermined value.

IV. State of Horizontal Cruise after Takeoff (Fourth Phase)

After airplane 43 reaches an objective altitude, it is traveling at a speed of about 900 km/hr. In the fourth phase, with an acceleration of 0 G, a gravity acceleration of 1.0 G is applied to information processing device 100 in a vertical direction.

In sum, the acceleration detection device can detect according to the movement of airplane, the magnitude and direction of the gravity acceleration and the acceleration applied to information processing device 100. More specifically, information processing device 100 can detect takeoff of airplane, so when takeoff is detected, such information is sent to a radio wave transmission stopping unit 14, whereby radio wave transmission can be controlled at the time of takeoff.

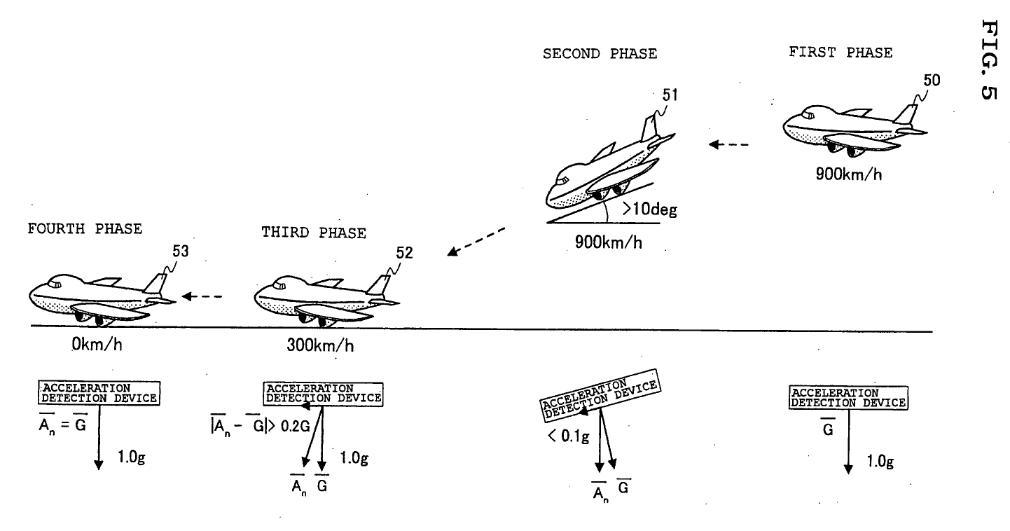

Referring now to FIG. 5, there is depicted an embodiment of the present invention when an airplane makes a landing. Airplanes 50 to 53 shown in FIG. 5 represent the state of airplane in the order of time (a first phase to a fourth phase). Airplanes 50-53 represent the same airplane. Herein, acceleration detection device denotes a device including acceleration detection unit 12. Information processing device 100 equipped with acceleration detection device 12 is on board with the airplane.

I. State of Horizontal Cruise (First Phase)

In the first phase, airplane 50 is traveling at a constant speed of 900 km/hr. Acceleration in a direction perpendicular to airplane 50 and a gravity direction is 0 G. A gravity acceleration of 1.0 G is applied to information processing device 100.

Information processing device 100 has been turned off or entered to a standby state by a user operation. However, sub CPU 10 is active, and acceleration detection unit 12 detects a gravity acceleration and an acceleration applied to information processing device 100.

Also, reference vector determination unit 11 determines a reference vector (G). In the present example, reference vector determination unit 11 determines a reference vector (G) down in a vertical direction. Sub CPU 10 repeats the determination of a reference vector until information processing device 100 is turned on or returned from a standby state by the user operation.

II. State of Nose-Down for Landing (Second Phase)

After starting to make a landing, until airplane 51 reaches an objective altitude, it is going down by a tilt of about 10 degrees or more relative to the horizontal line. In the second phase, an acceleration of about 0.1 G or less in the direction of movement and a gravity acceleration of 1.0 G in a vertical direction are applied to information processing device 100.

Information processing device 100 detects a direction of acceleration vector and then determines that airplane 51 inclines some angle. More specifically, flag setting unit 13 of information processing device 100 calculates an angle between the reference vector determined by the reference vector determination unit 11 and the acceleration vector, and checks that a first determination is satisfied in which it is determined whether or not the angle is larger than a predetermined value.

III. State of Speed Down for Landing (Third Phase)

After touched down, airplane 52 is moving at a speed of about 300 km/hr. In the third phase, in order to cause airplane 52 to make a landing, acceleration is applied so that speed is decreased in the direction of movement; applied to information processing device 100 are an acceleration of about 0.2 G or more in the direction of movement and a gravity acceleration of 1.0 G in a vertical direction. More specifically, flag setting unit 13 determines a difference between the reference vector (G) determined in the first phase and acceleration vector An, and calculates the absolute value of the difference, and thereby determines whether or not acceleration is larger than a predetermined value.

Flag setting unit 13 can check that a second determination is satisfied, that is, whether or not the magnitude of acceleration vector detected by acceleration detection unit 12 equal to or larger than a predetermined value and it continues more than a predetermined time period.

IV. Stationary State (Fourth Phase)

Subsequently, as a result of speed reduction, the speed of airplane 53 becomes 0 and airplane 53 stands still. In the fourth phase, with an acceleration of 0 G, a gravity acceleration of 1.0 G is applied to information processing device 100 in a vertical direction.

In sum, the acceleration detection device can detect according to the movement of airplane, the magnitude and direction of the gravity acceleration and the acceleration applied to information processing device 100. More specifically, information processing device 100 can detect landing of airplane, so when landing is detected, the flag for stopping radio wave transmission set at the time of takeoff can be reset.

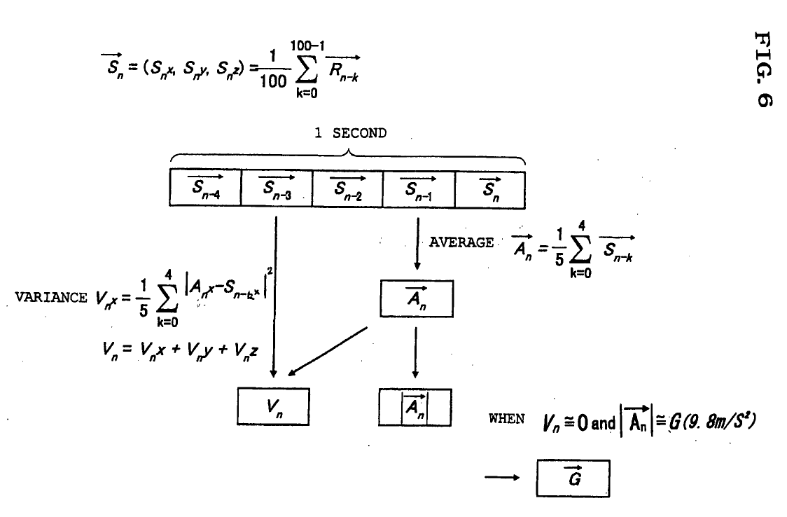

With reference now to FIG. 6, there is depicted a conceptual diagram for calculating a reference vector, in accordance with a preferred embodiment of the present invention. As described above, acceleration detection unit 12 detects the magnitude and direction of gravity acceleration applied when information processing device 100 is placed in any given direction, and reference vector determination unit 11 determines a reference vector based on the magnitude and direction of gravity acceleration detected.

Specifically, through a first to fifth steps described below, reference vector determination unit 11 determines a reference vector.

In the first step, acceleration detection unit 12 detects an acceleration vector R(n) applied to information processing device 100 at an interval of 2 msec.

In the second step, reference vector determination unit 11 calculates an acceleration vector S(n) obtained by averaging the acceleration vector R(n) every 0.2 sec.

More specifically, an acceleration vector S(n) is calculated by

$$\overline{{S}_{n}} = ( {S}_{n} x , {S}_{n} y , {S}_{n} z ) = \frac{1}{100} {\sum }_{k = 0}^{100 - 1} \overline{{R}_{n - k}}$$

\overline{R}ₙ is a raw vector recorded at an interval of 1 msec.

In the third step, reference vector determination unit 11 calculates an average acceleration vector A(n) based on the latest five acceleration vectors S(n), S(n-1), S(n-2), S(n-3) and S(n-4) selected from among the acceleration vectors S(n). More specifically, 20 an average acceleration vector A(n) is calculated by

$$\overline{{A}_{n}} = \frac{1}{5} {\sum }_{k = 0}^{4} \overline{{S}_{n - k}}$$

\overline{A}ₙ is an average value vector.

In the fourth step, reference vector determination unit 11 calculates a variance V(n) based on the average acceleration vector A(n) calculated in the third step and the latest five acceleration vectors S(n), S(n-1), S(n-2), S(n-3) and S(n-4) selected from among the acceleration vectors S(n). More specifically, a variance V(n) is calculated by

$$\overline{{V}_{n}} x = \frac{1}{5} {\sum }_{k = 0}^{4} {\vert \overline{{A}_{n} x} - \overline{{S}_{n - k}} x \vert}^{2}$$

Vₙ is a variance (Vₙ=Vₙx+Vₙy+Vₙz)

In the fifth step, when variance V(n)≈0 and the magnitude of average acceleration vector A(n)≈G (G: gravity acceleration, 9.8 m/sec(sec), reference vector determination unit 11 defines the average acceleration vector A(n) as reference vector G.

Variance V(n)≈0 indicates that the acceleration applied to information processing device 100 is constant. Specifically, variance V(n)≈0 indicates that information processing device 100 is in a stationary state and is not moving by vibration or rotation.

Accordingly, independently of the state in which information processing device 100 is placed, when a constant magnitude of gravity acceleration is applied in the settled direction for a given time period, this state is determined as the reference vector, it is determined as the reference acceleration applied to information processing device 100 in the normal operation state where information processing device 100 is not affected from any other acceleration except for gravity basically.

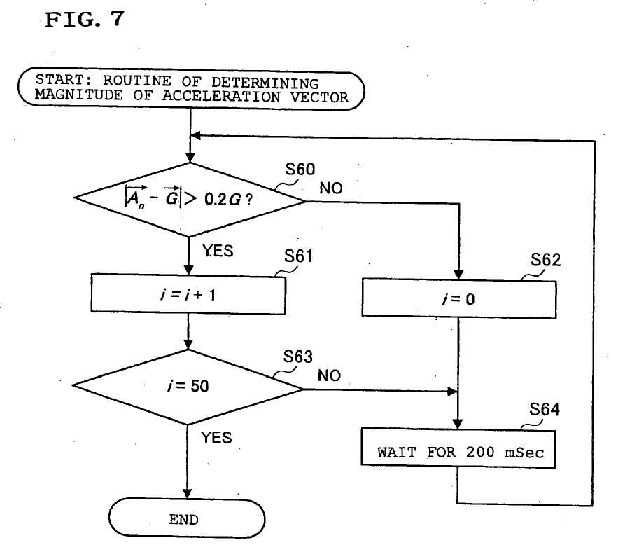

Referring now to FIG. 7, there is illustrated a flow of processing of flag setting unit 13 performing the first determination, in accordance with a preferred embodiment of the present invention. This processing flow represents the details of the determination shown in step S04 of FIG. 2. Flag setting unit 13 subtracts reference vector G from average acceleration vector A(n) detected by acceleration detection unit 12 and determines whether or not the absolute value of the result value is equal to or larger than 0.2 (G), as shown in step S60. If so, the flow proceeds to step S61; if not, the flow proceeds to step S62.

In step S61, one is added to counter i for determining the loop termination condition, and the flow proceeds to step S63. In step S63, a determination is made as to whether or not counter i is equal to 50. If so, the first determination processing is finished; if not, the flow proceeds to step S64. Herein, “counter i is equal to 50” indicates that 10 sec. (50(200/1000) has passed. In step S62, counter i is set to 0, and the flow proceeds to step S64. In step S64, there is a wait of 200 msec.

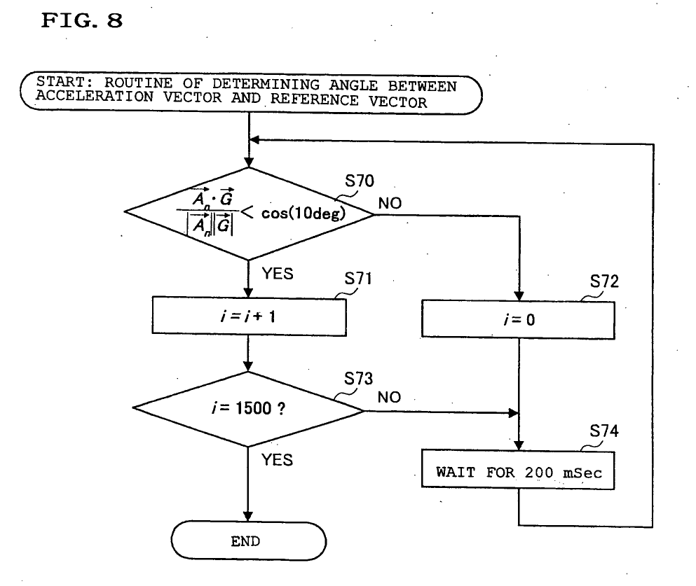

With reference now to FIG. 8, there is depicted a flow of processing of the flag setting unit 13 performing the second determination, in accordance with a preferred embodiment of the present invention. This processing flow represents details of the determination shown in step S05 of FIG. 2. Flag setting unit 13 determines whether or not a value obtained by dividing an angle between acceleration and reference vector by a value obtained by multiplying the magnitude of the acceleration vector by the magnitude of the reference is equal to or smaller than the cosine of the flying angle (10 degrees), as shown in step S70. If so, the flow proceeds to step S71; if not, the flow proceeds to step S72.

In step S71, one is added to counter i for determining the loop termination condition, and the flow proceeds to step S73. In step S73, a determination is made as to whether or not counter i is equal to 1500. If so, the second determination processing is finished; if not, the flow proceeds to S74. Herein, “counter i is equal to 1500” indicates that 5 min. (1500(200/1000/60) has passed. In step S72, counter i is set to 0, and the flow proceeds to step S74. In step S74, there is a wait of 200 msec.

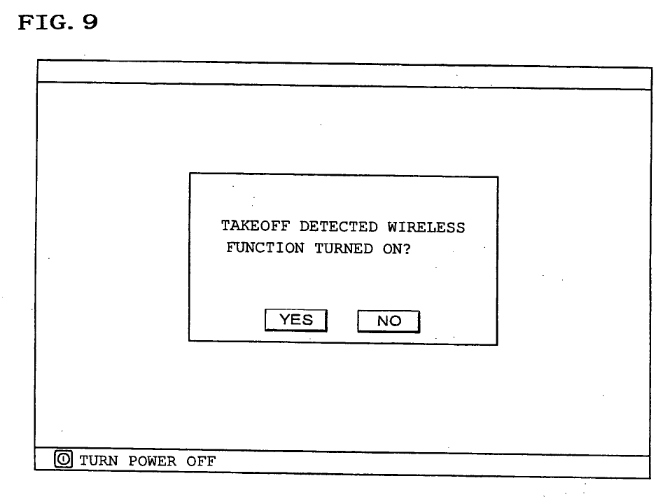

Referring now to FIG. 9, there is graphically illustrated an image shown on a display unit when radio wave transmission is stopped. This output processing is executed when information processing device 100 is turned on or when information processing device 100 is returned from a standby state, as shown in step S10 of FIG. 3.

Specifically, sub CPU 10 performs a control of stopping/permitting radio wave transmission and executes a program (application) for outputting the contents of the control to display unit 21 (from FIG. 1), whereby the information indicating the stopping of radio wave transmission is outputted to display unit 21. Accordingly, a user can confirm from the contents outputted to display unit 21 that radio wave transmission has been stopped. If the user wants to modify the setting for stopping/permitting radio wave transmission, the setting can be modified.

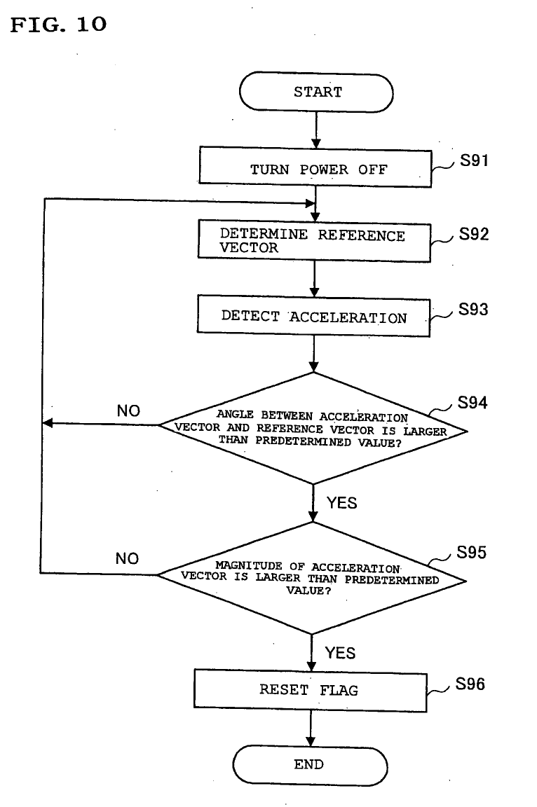

With reference now to FIG. 10, there is depicted a high-level logic flow diagram of a method for resetting a stopping flag, in accordance with a preferred embodiment of the present invention. More specifically, in this processing flow, there is shown a flow of processing of resetting a stopping flag that has been set in memory 22 in the processing flow of FIG. 2.

In FIG. 10, there is shown a flow of processing of a notebook PC acquiring the information on landing when the notebook PC in a standby state has been brought on an airplane by the passenger and the airplane makes a landing. The flow of processing according to the present embodiment is substantially the same as the flow of processing of FIG. 2, and only the differences will be described.

In the present flow of processing, the order of step S04 (first determination) and step S05 (second determination) of FIG. 2 is opposite. More specifically, after the flag setting unit 13 determines whether or not an angle between the reference vector determined in step S92 and the acceleration vector generated in step S93 is larger than a predetermined value, as shown in step S94, the flag setting unit 13 determines whether or not the magnitude of the acceleration vector is larger than a predetermined value, as depicted in step S95.

For example, these determinations are performed in a sequence of processing steps in which, when the airplane makes a landing, the notebook PC acquires the information on landing and, when the user turns on the notebook PC, the notebook PC permits radio wave transmission. More specifically, it is determined in step S94 that the airplane is going to make a landing, and it is determined in step S95 that the airplane is slowing its speed after making a landing. If these conditions are met, flag setting unit 13 resets the stopping flag stored in memory 22, as shown in step S96.

If the stopping flag is reset, it is determined in step S08 of FIG. 3 that a stopping flag has not been set, and radio wave transmission from information processing device 100 is permitted.

The processing flow of FIG. 10 can be executed when a stopping flag has been set in step S06 and the airplane has been in a horizontal navigation state for a given time period after the setting of stopping flag. More specifically, information processing device 100 executes the processing flow (FIG. 10) for landing when it is checked that a stopping flag has been set and at the same time it is detected after the setting of stopping flag that the airplane is in the fourth phase.

According to the present invention, based on gravity acceleration and acceleration applied to information processing device 100 itself, information processing device 100 can stop radio wave transmission for itself automatically. Also, regardless of the ON/OFF state of information processing device 100, when a stopping flag has been set, radio wave transmission can be stopped independently. Further, a stopping flag for stopping radio wave transmission is set based on the magnitude and direction of acceleration. More specifically, not only the magnitude of acceleration applied to information processing device but also horizontal and vertical movements are taken into consideration. Accordingly, radio wave transmission can be stopped independently of horizontal movement.

It is also important to note that although the present invention has been described in the context of a fully functional information processing device, those skilled in the art will appreciate that the mechanisms of the present invention are capable of being distributed as a program product in a variety of forms, and that the present invention applies equally regardless of the particular type of signal bearing media utilized to actually carry out the distribution. Examples of signal bearing media include, without limitation, recordable type media such as floppy disks or compact discs and transmission type media such as analog or digital communications links.

As has been described, the present invention provides an improved method and apparatus for controlling radio wave transmission in a situation or a place where radio wave transmission from an information processing apparatus is prohibited.

While the invention has been particularly shown and described with reference to a preferred embodiment, it will be understood by those skilled in the art that various changes in form and detail may be made therein without departing from the spirit and scope of the invention.

What is claimed is:

1. A method for controlling transmission of radio wave generated by an information processing device located within an airplane, said method comprising:
detecting an acceleration applied to said information processing device;
setting a stopping flag in response to the magnitude of said detected acceleration and the magnitude of a tilt of said airplane determined based on said detected acceleration are larger than a predetermined value; and
stopping radio wave transmission in response to said stopping flag being set.

2. The method of claim 1, wherein said method further includes determining a reference vector serving as a reference for determining the degree of acceleration applied to said information processing device.

3. The method of claim 1, wherein said stopping flag is set in response to a tilt of said airplane is larger than a predetermined value when said airplane is gaining altitude.

4. The method of claim 1, wherein said method further includes resetting said stopping flag in response to said tilt of said airplane is larger than a predetermined value when said airplane is descending.

5. The method of claim 1, wherein said method further includes resetting based on a reference vector in response that an angle between said acceleration vector and said reference vector is larger than a predetermined value while a magnitude of said acceleration vector is larger than a predetermined value.

6. The method of claim 1, wherein said method further includes setting said stopping flag in response to said magnitude of said acceleration vector continues to be larger than a predetermined value for a predetermined time period or more and at the same time an angle between the acceleration and the reference vector is larger than a predetermined value.

7. The method of claim 1, wherein said method further includes setting said stopping flag in response to the magnitude of said acceleration vector is larger than a predetermined value while an angle between said acceleration vector and said reference vector continues to be larger than a predetermined value for a predetermined time period.

8. The method of claim 1, wherein said method further includes determining an average of gravity acceleration from said magnitude and a direction of gravity acceleration detected on a regular time period.

9. The method of claim 1, wherein said method further includes determining said reference vector from said average magnitude of the gravity acceleration and a variance calculated from an average of the gravity acceleration and gravity accelerations detected on a regular time period.

10. An apparatus for controlling transmission of radio wave generated by an information processing device located within an airplane, said apparatus comprising:
an acceleration detection unit for detecting an acceleration applied to said information processing device;
a flag setting unit for setting a stopping flag in response to the magnitude of said detected acceleration and the magnitude of a tilt of said airplane determined based on said detected acceleration are larger than a predetermined value; and
means for stopping radio wave transmission in response to said stopping flag being set.

11. The apparatus of claim 10, wherein said apparatus further includes means for determining a reference vector serving as a reference for determining the degree of acceleration applied to said information processing device.

12. The apparatus of claim 10, wherein said stopping flag is set in response to a tilt of said airplane is larger than a predetermined value when said airplane is gaining altitude.

13. The apparatus of claim 10, wherein said apparatus further includes means for resetting said stopping flag in response to said tilt of said airplane is larger than a predetermined value when said airplane is descending.

14. The apparatus of claim 10, wherein said apparatus further includes means for resetting based on a reference vector in response that an angle between said acceleration vector and said reference vector is larger than a predetermined value while a magnitude of said acceleration vector is larger than a predetermined value.

15. The apparatus of claim 10, wherein said apparatus further includes means for setting said stopping flag in response to said magnitude of said acceleration vector continues to be larger than a predetermined value for a predetermined time period or more and at the same time an angle between the acceleration and the reference vector is larger than a predetermined value.

16. The apparatus of claim 10, wherein said apparatus further includes means for setting said stopping flag in response to the magnitude of said acceleration vector is larger than a predetermined value while an angle between said acceleration vector and said reference vector continues to be larger than a predetermined value for a predetermined time period.

17. The apparatus of claim 10, wherein said apparatus further includes means for determining an average of gravity acceleration from said magnitude and a direction of gravity acceleration detected on a regular time period.

18. The apparatus of claim 10, wherein said apparatus further includes means for determining said reference vector from said average magnitude of the gravity acceleration and a variance calculated from an average of the gravity acceleration and gravity accelerations detected on a regular time period.
